(19) United States
(12) Patent Application Publication
(10) Pub. No.: US 2024/0353992 A1
(43) Pub. Date: Oct. 24, 2024

(54) EMOJI VISUALIZER

(71) Applicant: Emoji ID, LLC, Oakland, CA (US)

(72) Inventors: Naveen JAIN, Nashville, TN (US); Riccardo SPAGNI, Plettenburg (ZA); Keith SIMON, Vancouver (CA)

(73) Assignee: Emoji ID, LLC, Oakland, CA (US)

(21) Appl. No.: 18/136,315

(22) Filed: Apr. 18, 2023

(51) Int. Cl. G06F 3/04847; G06F 3/04817; H04L 9/32

(52) U.S. Cl. CPC G06F 3/04847; G06F 3/04817; H04L 9/3247

(57) ABSTRACT

Implementations generally relate to an emoji visualizer. In some implementations, a method includes generating at least one emoji identifier (ID), wherein the at least one emoji ID is digitally signed with a private encryption key, and wherein the emoji ID is associated with a user. The method further includes displaying an emoji visualizer on a client device, wherein the emoji visualizer is a user interface for customizing background patterns for emoji IDs, and wherein the emoji visualizer comprises a window and a plurality of controls. The method further includes displaying the at least one emoji ID in the window of the emoji visualizer. The method further includes receiving one or more commands based on the plurality of controls of the emoji visualizer. The method further includes generating a background pattern for the at least one emoji ID, wherein the background pattern is based on the one or more commands. The method further includes displaying the background pattern with the at least one emoji ID in the window of the emoji visualizer.

### SUMMARY

In some implementations, a method includes generating at least one emoji identifier (ID), wherein the at least one emoji ID is digitally signed with a private encryption key, and wherein the emoji ID is associated with a user. The method further includes displaying an emoji visualizer on a client device, wherein the emoji visualizer is a user interface for customizing background patterns for emoji IDs, and wherein the emoji visualizer comprises a window and a plurality of controls. The method further includes displaying the at least one emoji ID in the window of the emoji visualizer. The method further includes receiving one or more commands based on the plurality of controls of the emoji visualizer. The method further includes generating a background pattern for the at least one emoji ID, wherein the background pattern is based on the one or more commands. The method further includes displaying the background pattern with the at least one emoji ID in the window of the emoji visualizer.

### BRIEF DESCRIPTION OF THE DRAWINGS

FIG. 1 is a block diagram of an example emoji visualizer 100 for customizing a background pattern for an emoji identifier (ID), which may be used for implementations described herein.

FIG. 2 is an example flow diagram for implementing an emoji visualizer, according to some implementations.

FIG. 3 is a block diagram of an example emoji visualizer and resulting background pattern for an emoji ID, according to some implementations.

FIG. 4 is a block diagram of an example emoji visualizer and another resulting background pattern for an emoji ID, according to some implementations.

FIG. 5 is a block diagram of an example emoji visualizer and another resulting background pattern for an emoji ID, according to some implementations.

FIG. 6 is a block diagram of an example emoji visualizer and another resulting background pattern for an emoji ID, according to some implementations.

FIG. 7 is a block diagram of an example emoji visualizer and another resulting background pattern for an emoji ID, according to some implementations.

FIG. 8 is a block diagram of an example emoji visualizer and another resulting background pattern for an emoji ID, according to some implementations.

FIG. 9 is a block diagram of an example network environment, which may be used for some implementations described herein.

FIG. 10 is a block diagram of an example computer system, which may be used for implementations described herein.

### DETAILED DESCRIPTION

Implementations described herein provide an emoji visualizer. The emoji visualizer adds visual interest to emoji identifiers (IDs) by adding dynamic background patterns to emoji IDs. Such background patterns are dynamic in that they are animated. As described in more detail herein, in various implementations, a system generates at least one emoji identifier (ID)), where the at least one emoji ID is digitally signed with a private encryption key, and where the emoji ID is associated with a user. The system displays an emoji visualizer on a client device, where the emoji visualizer is a user interface for customizing background patterns for emoji IDs, and where the emoji visualizer comprises a window and sets of controls. The system displays the emoji ID in the window of the emoji visualizer. After the system receives one or more commands based on the controls of the emoji visualizer, the system further generates a background pattern for the emoji ID based on the received commands. The system displays the background pattern with the at least one emoji ID in the window of the emoji visualizer.

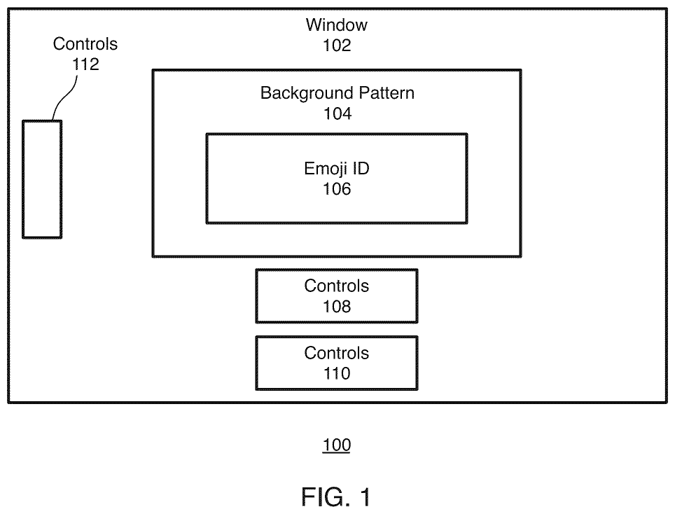

FIG. 1 is a block diagram of an example emoji visualizer 100 for customizing a background pattern for an emoji identifier (ID), which may be used for implementations described herein. In various implementations, emoji visualizer 100 is a user interface for customizing background patterns for emoji IDs. As shown, emoji visualizer 100 includes a window 102 that displays an emoji ID 106, a background pattern 104, and sets of controls, 108, 110, and 112.

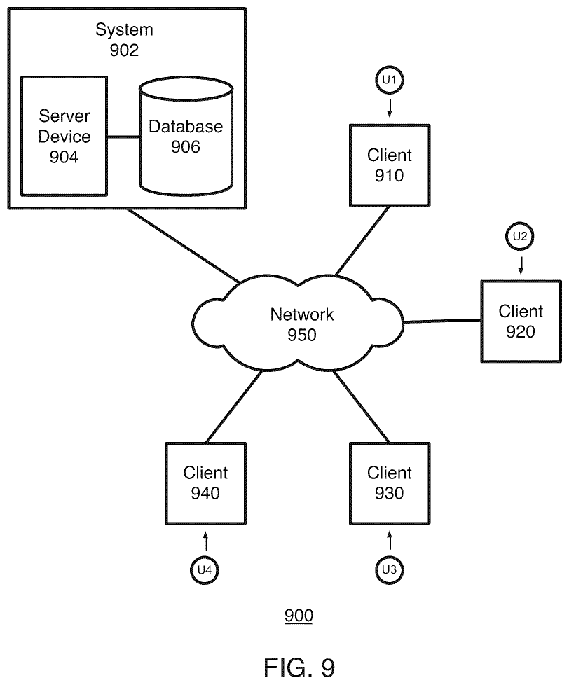

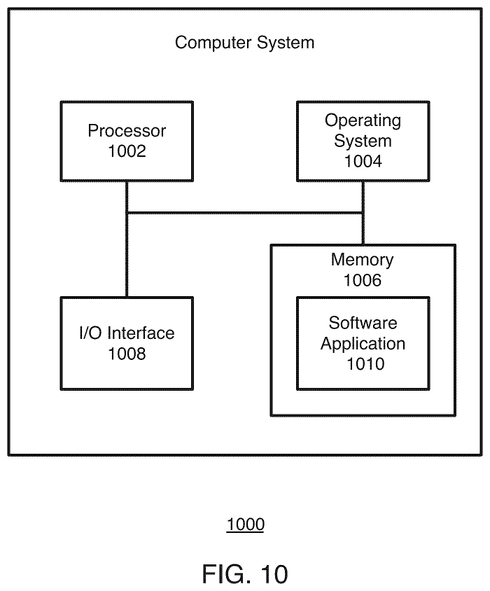

A system such as system 900 of FIG. 9 and/or system 1000 of FIG. 10 enables a user to customize background pattern 104 for emoji ID 106. As described in more detail herein, the system displays emoji visualizer 100 on a client device associated with a user The client device (not shown) may be any suitable device such as a smartphone, a tablet, a notebook computer, a desktop computer, etc. As indicated above, emoji visualizer 100 enables a user to customize one or more background patterns for an emoji ID associated with the user. In various implementations, a user may own multiple emoji IDs, such as a personal emoji ID, a business entity emoji ID, etc.

After the system generates emoji ID 106, the system displays emoji ID 106 in window 102 of emoji visualizer 100. The system enables the user to manipulate controls 108, 110, and 112 to specify various attributes of background pattern 104, which the system displays in window 102 with emoji ID 106. Based on commands received via controls 108, 110, and 112, the system generates and displays background pattern 104 for the emoji ID 106. The system displays the background pattern with the at least one emoji ID in the window of the emoji visualizer.

While various implementations are described herein in the context of emoji IDs, these implementations and others may also have other applications. For example, the system may apply various implementations described herein to cryptocurrencies or crypto assets such as non-fungible tokens (NFTs). For example, the system may apply a background pattern similar to one described herein to an NFT, etc.

While system 900 of FIG. 9 and/or system 1000 of FIG. 10 perform implementations described herein, in other implementations, any suitable component or combination of components associated with systems 900 and/or 1000 or any suitable processor or processors associated with systems 900 and/or 1000 may facilitate performing the implementations described herein.

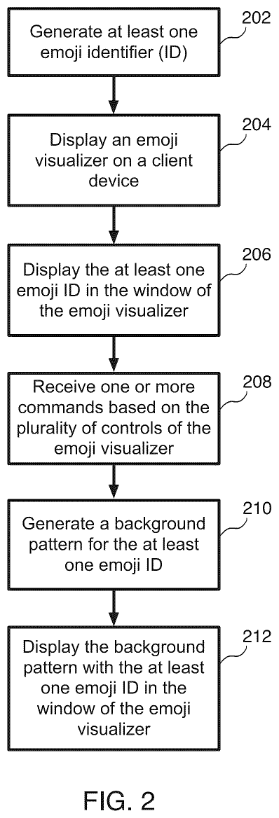

FIG. 2 is an example flow diagram for implementing an emoji visualizer, according to some implementations. Referring to both FIGS. 1 and 2, a method is initiated at block 202, where a system such as system 900 of FIG. 9 and/or system 1000 of FIG. 10 computes and generates at least one emoji ID of a user such as emoji ID 106. In various implementations, emoji ID 106 is digitally signed with a private encryption key of the user, where emoji ID 106 is associated with the user. In various implementations, the emoji ID may represent or be associated with a particular user or entity. In some implementations, if the emoji ID is associated with an entity, any one or more designated users may be authorized to take actions on behalf of the entity, including using emoji visualizer 100 to configure a customized background pattern for the emoji ID.

At block 204, the system displays emoji visualizer 100 on a client device (not shown), such as a client device associated with the user. The client device may be any suitable device such as a smartphone, a tablet, a notebook computer, a desktop computer, etc.

As described in more detail herein, emoji visualizer 100 is a user interface for customizing background patterns for emoji IDs. In various implementations, emoji visualizer 100 provides sets of controls 108, 110, and 112 in window 102 that the user may manipulate to specific various attributes of background pattern 104. In various implementations, the system may provide any number of sets of controls and any number of controls in a given set.

At block 206, the system displays emoji ID 106 in the window of the emoji visualizer. In various implementations, emoji ID 106 may include one or more emojis. For example, emoji ID 106 may include a sequence or string of some combination of emojis that identifies the user. Emojis may be utilized to provide a user with an easy and intuitive way to identify a person (e.g., the user) or an entity. Emojis are miniature pictures that can be used to express thoughts, ideas, and concepts, that can be entered using a keyboard or software application, and can be entered without using alpha-numeric characters. Emojis are often easier to remember for a typical internet user than an alpha-numeric address. As such, a sequence of emojis rather than an alpha-numeric sequence may be better suited to ensuring that a user or customer can successfully access information pertaining to a person or entity associated with a particular emoji ID.

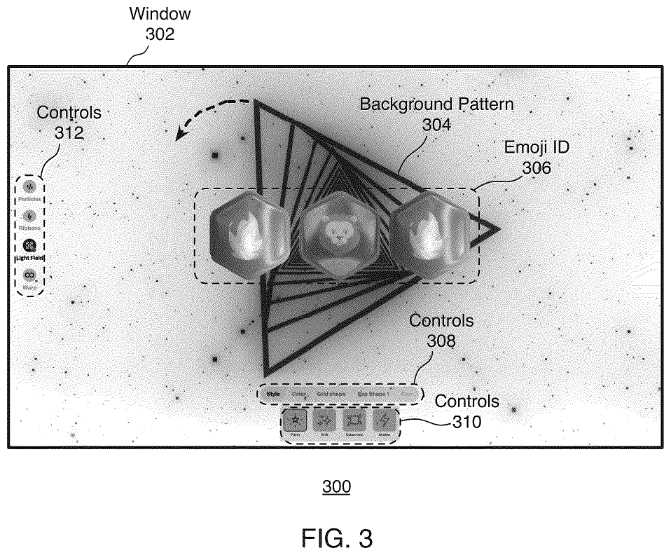

In some implementations, an emoji ID may include a mixture of emoji and non-emoji characters, as well as sequences that do not include emojis can also fall within the scope of the disclosure. An example emoji ID is shown in connection with FIGS. 3-8 below.

At block 208, the system receives one or more commands based on the plurality of controls of the emoji visualizer. As described in more detail below, the commands are associated with a variety of algorithms and rules for configuring and rendering specify aspects such as style, color, size, shape, behavior, etc. of a fully customized and unique background pattern. Such commands may determine, for example, sizes, shape, etc. of elements of a background pattern, where such elements are positioned (e.g., pixel positions, etc.) on a given user interface screen or display, etc. Various example implementations of commands are described in more detail herein, in connection with FIGS. 3-8, for example.

At block 210, the system generates background pattern 104 for emoji ID 106, where background pattern 104 is based on the one or more commands. FIGS. 3-8 below show various example implementations of background patterns.

At block 212, the system displays background pattern 104 with emoji ID 106 in window 102 of emoji visualizer 100. In various implementations, a background pattern enhances the visual appeal of an emoji ID, giving the emoji ID additional artistic qualities and beauty like NFTs, for example. Various examples of background patterns with emoji IDs are described in more detail herein.

While various implementations are described herein in the context of a single background pattern, the system may also enable a user to configure multiple layers of background patterns for a given emoji ID. In some implementations, the system may enable a user to generate multiple layers of background patterns to be displayed simultaneously with the associated emoji ID.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 3 is a block diagram of an example emoji visualizer 300 and resulting background pattern for an emoji ID, according to some implementations. Similar to emoji visualizer 100 of FIG. 1, emoji visualizer 300 of FIG. 3 includes a window 302, which displays a background pattern 304, an emoji ID 306, and sets of controls 308, 310, and 312.

In various implementations, emoji ID 306 may include one or more emojis. In the example shown, emoji ID 306 includes an emoji string of three emojis, which in this example includes a fire emoji, a lion emoji, and another fire emoji. The particular number of emojis in an emoji ID may vary, depending on the particular implementation.

In various implementations, the background pattern provides a visual context in association with the emoji ID. The particular attributes of the background pattern vary, depending on the control selections by the user. In various implementations, controls 308, 310, and 312 include buttons associated with different functions. For example, controls 308 have control options such as style, color, grid shape, pop shape, etc. The particular selection may vary, depending on the particular implementation.

In various implementations, the particular controls of controls 310 change depending on which control of controls 308 is selected. In this particular example, style is selected. The corresponding controls 308 include prism, chill, cybernetic, shatter, etc. Each of these indicates different behavior. For example, in this particular example, prism is selected, which adds a prism-like behavior to background pattern 304, the behavior of which is described in the following paragraph.

In various implementations, the background pattern is animated. The background pattern is animated in that it changes continuously, similar to a video, which provides continuous visual appeal to emoji IDs. For example, background pattern 304 is shown in a static snapshot in FIG. 3. However, the behavior of background pattern 304 is a prism animation such that the shapes (e.g., triangles, etc.) shown move continuously toward the viewer, grow increasingly larger, and rotate counter-clockwise as indicated by the dashed arrow. The particular shape and movement may vary, depending on the particular controls selected.

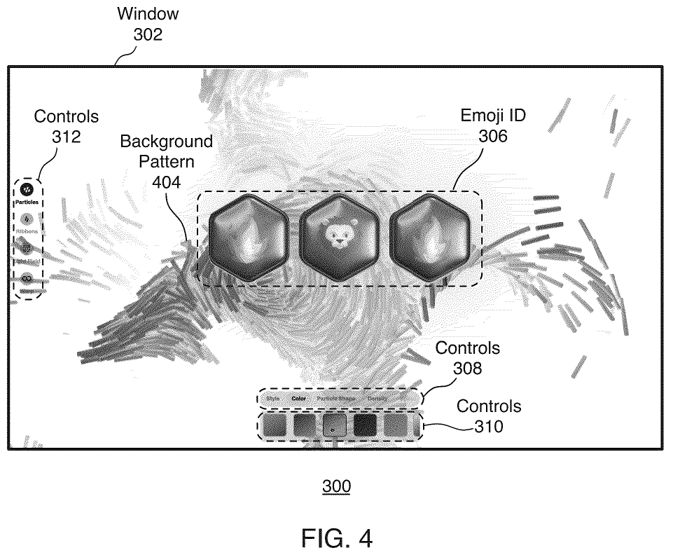

Controls 312 show other controls that provide various effects on the background pattern. For example, shown are particles, ribbons, light field, and warp. In this particular example, light field is selected, which gives a light field effect. The following FIGS. 4-8, show the same emoji visualizer 300 with different background pattern examples.

FIG. 4 is a block diagram of example emoji visualizer 300 and another resulting background pattern for an emoji ID, according to some implementations. Shown are window 302, which displays a background pattern 404, emoji ID 306, and sets of controls 308, 310, and 312. The elements of FIG. 4 are similar to those of FIG. 3 except for the background pattern and some controls.

In various implementations, one or more controls configures one or more parameters of the background pattern. Also, one or more controls configures one or more behaviors of the at least one emoji ID. In various implementations, the parameters are visual parameters. For example, the parameters may involve shapes of components of the background pattern, texture portions of the background pattern, etc. The particular parameters may vary as shown and described herein in connection with the various example background patterns. For example, some parameters may involve movement of background pattern components, movement patterns, movement speed, etc. The system enables a user to manipulate controls described herein to fully configure a background pattern for an emoji ID.

In this particular example, the particles control is selected from controls 312. As such, background pattern 404 consists of particles that are of a particular shape. The particles of the background pattern are animated in that they move in groups in the background. Of controls 308, the color control is selected. Selecting the color control changes controls 310 to include various color controls. Shown are different shades that represent different colors, the selection of which changes the colors of the particles in background pattern 404

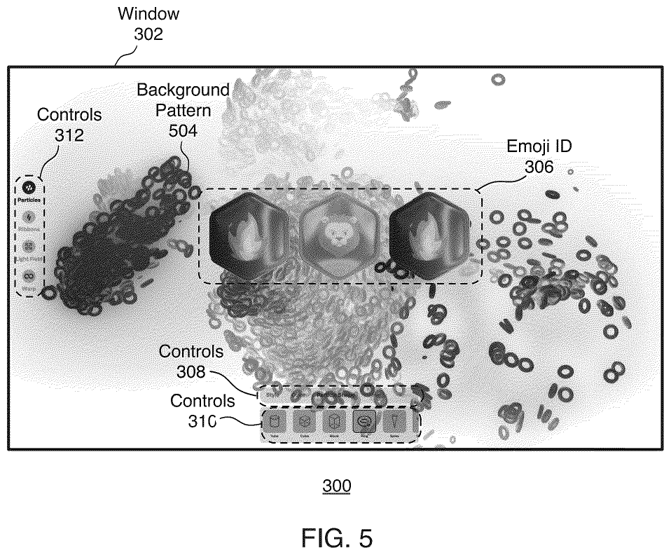

FIG. 5 is a block diagram of an example emoji visualizer 500 and another resulting background pattern for an emoji ID, according to some implementations. Shown are window 302, which displays a background pattern 504, emoji ID 306, and sets of controls 308, 310, and 312. The elements of FIG. 5 are similar to those of FIG. 3 except for the background pattern and some controls.

In this particular example, the particles control is selected from controls 312. As such, background pattern 504 consists of particles that of a particular shape. The particles of the background pattern are animated in that they move in groups in the background. Of controls 308, the particle shape control is selected. Selecting the particle shape control changes controls 310 to include various shape controls. The selection of any of the shapes changes the shapes of the particles in background pattern 504.

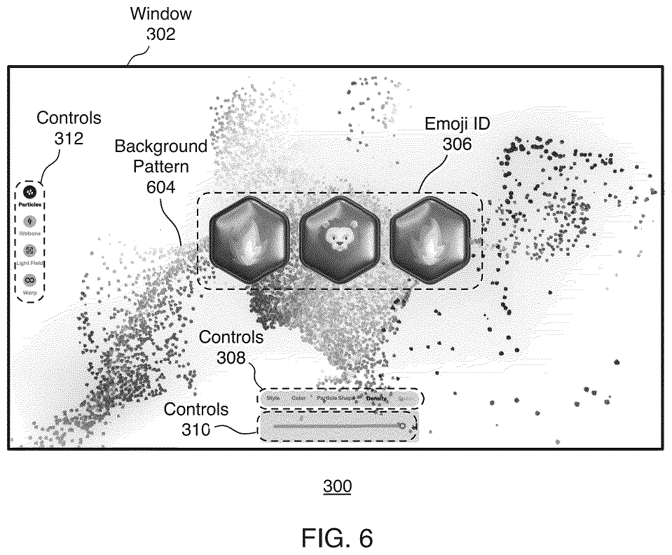

FIG. 6 is a block diagram of an example emoji visualizer 600 and another resulting background pattern for an emoji ID, according to some implementations. Shown are window 302, which displays a background pattern 604, emoji ID 306, and sets of controls 308, 310, and 312. The elements of FIG. 6 are similar to those of FIG. 3 except for the background pattern and some controls.

In this particular example, the particles control is selected from controls 312. As such, background pattern 604 consists of particles that are of a particular shape. The particles of the background pattern are animated in that they move in groups in the background. Of controls 308, the density control is selected. Selecting the density control changes controls 310 to include a slider. In some implementations, moving the slider to the left makes the particles of background pattern 604 less dense. Conversely, moving the slider to the right makes the particles of background pattern 604 more dense. The particular direction of the slider and corresponding density level may vary, and will depend on the particular implementation.

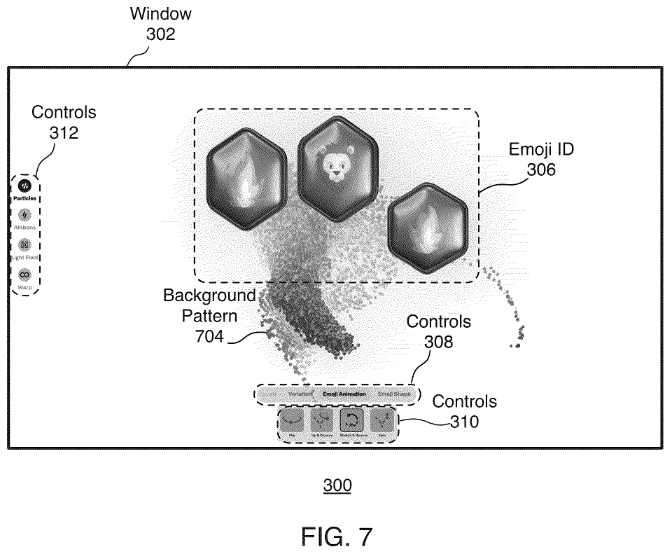

FIG. 7 is a block diagram of an example emoji visualizer 700 and another resulting background pattern for an emoji ID, according to some implementations. Shown are window 302, which displays a background pattern 704, emoji ID 306, and sets of controls 308, 310, and 312. The elements of FIG. 7 are similar to those of FIG. 3 except for a change in behavior of emoji ID 306 and some controls.

In this particular example, the particles control is selected from controls 312. As such, background pattern 704 consists of particles that are of a particular shape. The particles of the background pattern are animated in that they move in groups in the background. Of controls 308, the emoji animation control is selected. Selecting the emoji animation control changes controls 310 to include various emoji animation controls. Included are flip, flip and bounce, stretch and bounce, spin, etc. The selection any of the emoji animation controls changes the behavior of the emoji ID. In this particular example, the stretch and bound control is selected. This results in the emojis of emoji ID 306 stretching as they bounce upward.

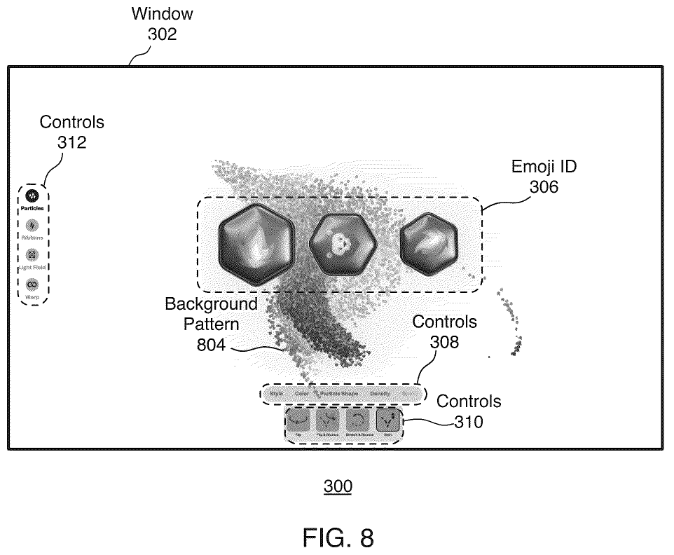

FIG. 8 is a block diagram of an example emoji visualizer 800 and another resulting background pattern for an emoji ID, according to some implementations. Shown are window 302, which displays a background pattern 804, emoji ID 306, and sets of controls 308, 310, and 312. The elements of FIG. 8 are similar to those of FIG. 3 except for a change in behavior of emoji ID 306 and some controls.

In this particular example, the particles control is selected from controls 312. As such, background pattern 804 consists of particles that are of a particular in shape. The particles of the background pattern are animated in that they move in groups in the background. Of controls 308, the emoji animation control is selected. As indicated above, selecting the emoji animation control changes controls 310 to include various emoji animation controls. Included are flip, flip and bounce, stretch and bounce, spin, etc. The selection of any of the emoji animation controls changes the behavior of the emoji ID. In this particular example, the spin control is selected. This results in the emojis of emoji ID 306 spinning in place.

In various implementations, the background pattern is locked in when the emoji ID is minted. For example, when the system generates emoji ID 306 for the user, emoji ID 306 is not automatically minted. In various implementations, the system mints emoji ID 306 after the user has specified and configured the parameters of the background pattern using the controls. The system locks the background pattern when the system mints emoji ID 306. In various implementations, the system may mint an emoji ID similarly to minting any cryptocurrency such as Ethereum-based tokens, and other types of cryptocurrency tokens, etc., and/or any crypto asset such as an NFT, etc. Once an emoji ID is minted with its associated background pattern, the system may store the emoji ID together with its associated background pattern in a database or any suitable storage location for future access.

In various implementations, the system enables the user to share the background pattern with other users, wherein the background pattern is displayed with the emoji ID. For example, when the user shares or uses the user's emoji ID, the recipient user or users see both the emoji ID and the background pattern together in a display.

In some implementations, the system may generate and assign a uniform resource locator (URL) to a background pattern. The system may create and assign the URL before or when the associated emoji ID is minted. The URL may provide simple, convenient access to the background pattern. A URL may be stored with any metadata associated with an emoji ID. In some implementations, a given emoji ID may be displayed optionally with a background pattern or optionally displayed without a background pattern. In some implementations, the system may also export the rendered asset (e.g., background pattern, etc.) in a video file such as a graphics interchange format (GIF) file, etc.

In various implementations, the system may enable a user to select a soundtrack to be associated with a given emoji ID. The emoji ID may be displayed optionally with the soundtrack being played or optionally displayed without the soundtrack being played. In some implementations, for example, the system may play the soundtrack while rendering an emoji ID along with an associated background pattern. In some implementations, the system may also export any soundtrack along with any rendered asset (e.g., background pattern, etc.) in a video file such as a GIF file, etc.

In various implementations, the system includes a blockchain network (not shown) having nodes, where each node maintains respective copies of a blockchain. The blockchain network may include hundreds or thousands of nodes. Also, the blockchain network may be a distributed peer-to-peer network. In some implementations, the blockchain network may implement known consensus algorithms to validate transactions submitted to the blockchain network. A verified transaction may include transferred cryptocurrency, contracts, records, or other information to be recorded to the blockchain. In some embodiments, multiple transactions are combined together into a block of data that is verified across a blockchain network. Once verified, this block of data can be added to an existing blockchain.

In various implementations, the blockchain includes a distributed ledger that maintains emoji IDs. In various implementations, the blockchain of the system may verify an emoji ID by checking the emoji ID against the base node of the blockchain to determine the authenticity or validity of the emoji ID. As indicated herein, the system may also display a background pattern along with the emoji ID

In various implementations, emoji IDs and associated background patterns may be associated with public and private keys. Public and private keys are an integral component of cryptocurrencies and other digital assets such as NFTs built on blockchain networks and are part of a larger field of cryptography known as public-key cryptography (PKC) or asymmetric encryption. The goal of PKC is to easily transition from a first state (e.g., a private key) to a second state (e.g., a public key), while making reversing the transition from the second state to the first state nearly impossible, and in the process, proving possession of a secret key without exposing that secret key. The product is subsequently a one-way mathematical function, which makes it ideal for validating the authenticity of transactions such as cryptocurrency transactions because possession of the first state such as the secret key cannot be forged. PKC relies on a two-key model, the public and private key The general purpose of PKC is to enable secure, private communication using digital signatures in a public channel that is susceptible to potentially malicious eavesdroppers.

Implementations described herein provide various benefits. For example, implementations enable a user to further customize an emoji ID by adding customized background patterns to be displayed with the emoji ID. Implementations also enable a user to further customize an emoji ID by adding behaviors to the emoji ID.

FIG. 9 is a block diagram of an example network environment 900, which may be used for some implementations described herein. In some implementations, network environment 900 includes a system 902, which includes a server device 904 and a database 906. System 902 may be used to perform implementations described herein Network environment 900 also includes client devices 910, 920, 930, and 940, which may communicate with system 902 and/or may communicate with each other directly or via system 902. Network environment 900 also includes a network 950 through which system 902 and client devices 910, 920, 930, and 940 communicate. Network 950 may be any suitable communication network such as a Wi-Fi network, Bluetooth network, the Internet, etc.

For ease of illustration, FIG. 9 shows one block for each of system 902, server device 904, and network database 906, and shows four blocks for client devices 910, 920, 930, and 940. Blocks 902, 904, and 906 may represent multiple systems, server devices, and network databases. Also, there may be any number of client devices. In other implementations, environment 900 may not have all of the components shown and/or may have other elements including other types of elements instead of, or in addition to, those shown herein.

While server device 904 of system 902 performs implementations described herein, in other implementations, any suitable component or combination of components associated with system 902 or any suitable processor or processors associated with system 902 may facilitate performing the implementations described herein.

In the various implementations described herein, a processor of system 902 and/or a processor of any client device 910, 920, 930, and 940 cause the elements described herein (e.g., information, etc.) to be displayed in a user interface on one or more display screens.

FIG. 10 is a block diagram of an example computer system 1000, which may be used for some implementations described herein. For example, computer system 1000 may be used to implement server device 904 of FIG. 9, as well as to perform implementations described herein. In some implementations, computer system 1000 may include a processor 1002, an operating system 1004, a memory 1006, and an input/output (I/O) interface 1008. In various implementations, processor 1002 may be used to implement various functions and features described herein, as well as to perform the method implementations described herein. While processor 1002 is described as performing implementations described herein, any suitable component or combination of components of computer system 1000 or any suitable processor or processors associated with computer system 1000 or any suitable system may perform the steps described. Implementations described herein may be carried out on a user device, on a server, or a combination of both.

Computer system 1000 also includes a software application 1010, which may be stored on memory 1006 or on any other suitable storage location or computer-readable medium. Software application 1010 provides instructions that enable processor 1002 to perform the implementations described herein and other functions. Software application 1010 may also include an engine such as a network engine for performing various functions associated with one or more networks and network communications. The components of computer system 1000 may be implemented by one or more processors or any combination of hardware devices, as well as any combination of hardware, software, firmware, etc.

For ease of illustration, FIG. 10 shows one block for each of processor 1002, operating system 1004, memory 1006, I/O interface 1008, and software application 1010. These blocks 1002, 1004, 1006, 1008, and 1010 may represent multiple processors, operating systems, memories, I/O) interfaces, and software applications. In various implementations, computer system 1000 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (Saas) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
generating at least one emoji identifier (ID), wherein the at least one emoji ID is digitally signed with a private encryption key, and wherein the emoji ID is associated with a user,
displaying an emoji visualizer on a client device, wherein the emoji visualizer is a user interface for customizing background patterns for emoji IDs, and wherein the emoji visualizer comprises a window and a plurality of controls;
displaying the at least one emoji ID in the window of the emoji visualizer;
receiving one or more commands based on the plurality of controls of the emoji visualizer;
generating a background pattern for the at least one emoji ID, wherein the background pattern is based on the one or more commands; and
displaying the background pattern with the at least one emoji ID in the window of the emoji visualizer.

2. The system of claim 1, wherein the at least one emoji ID comprises one or more emojis.

3. The system of claim 1, wherein the background pattern is animated.

4. The system of claim 1, wherein one or more controls of the plurality controls configures one or more parameters of the background pattern.

5. The system of claim 1, wherein one or more controls of the plurality controls one or more behaviors of the at least one emoji ID.

6. The system of claim 1, wherein the background pattern is locked in when the at least one emoji ID is minted.

7. The system of claim 1, wherein the logic when executed is further operable to cause the one or more processors to perform operations comprising enabling the user to share the background pattern with other users, wherein the background pattern is displayed with the at least one emoji ID.

8. A non-transitory computer-readable storage medium with program instructions stored thereon, the program instructions when executed by one or more processors are operable to cause the one or more processors to perform operations comprising:
generating at least one emoji identifier (ID), wherein the at least one emoji ID is digitally signed with a private encryption key, and wherein the emoji ID is associated with a user;
displaying an emoji visualizer on a client device, wherein the emoji visualizer is a user interface for customizing background patterns for emoji IDs, and wherein the emoji visualizer comprises a window and a plurality of controls;
displaying the at least one emoji ID in the window of the emoji visualizer;
receiving one or more commands based on the plurality of controls of the emoji visualizer;
generating a background pattern for the at least one emoji ID, wherein the background pattern is based on the one or more commands; and
displaying the background pattern with the at least one emoji ID in the window of the emoji visualizer.

9. The computer-readable storage medium of claim 8, wherein the at least one emoji ID comprises one or more emojis.

10. The computer-readable storage medium of claim 8, wherein the background pattern is animated.

11. The computer-readable storage medium of claim 8, wherein one or more controls of the plurality controls configures one or more parameters of the background pattern.

12. The computer-readable storage medium of claim 8, wherein one or more controls of the plurality controls one or more behaviors of the at least one emoji ID.

13. The computer-readable storage medium of claim 8, wherein the background pattern is locked in when the at least one emoji ID is minted.

14. The computer-readable storage medium of claim 8, wherein the instructions when executed are further operable to cause the one or more processors to perform operations comprising enabling the user to share the background pattern with other users, wherein the background pattern is displayed with the at least one emoji ID.

15. A computer-implemented method comprising:
generating at least one emoji identifier (ID), wherein the at least one emoji ID is digitally signed with a private encryption key, and wherein the emoji ID is associated with a user;
displaying an emoji visualizer on a client device, wherein the emoji visualizer is a user interface for customizing background patterns for emoji IDs, and wherein the emoji visualizer comprises a window and a plurality of controls;
displaying the at least one emoji ID in the window of the emoji visualizer;
receiving one or more commands based on the plurality of controls of the emoji visualizer;
generating a background pattern for the at least one emoji ID, wherein the background pattern is based on the one or more commands; and
displaying the background pattern with the at least one emoji ID in the window of the emoji visualizer.

16. The method of claim 15, wherein the at least one emoji ID comprises one or more emojis.

17. The method of claim 15, wherein the background pattern is animated.

18. The method of claim 15, wherein one or more controls of the plurality controls configures one or more parameters of the background pattern.

19. The method of claim 15, wherein one or more controls of the plurality controls one or more behaviors of the at least one emoji ID.

20. The method of claim 15, wherein the background pattern is locked in when the at least one emoji ID is minted.
